(19) United States
(12) Patent Application Publication
(10) Pub. No.: US 2018/0231097 A1
(43) Pub. Date: Aug. 16, 2018

(54) BLADE-TYPE TORSIONAL DAMPER

(71) Applicant: VALEO EMBRAYAGES, Amiens Cedex 2 (FR)

(72) Inventors: Daniel FENIOUX, Saleux (FR); Herve MAUREL, Amiens (FR)

(21) Appl. No.: 15/514,978

(22) PCT Filed: Sep. 24, 2015
(86) PCT No.: PCT/EP2015/072018

§ 371 Date: Mar. 28, 2017

(30) Foreign Application Priority Data
Oct. 1, 2014 (FR) 1459347

(51) Int. Cl. F16F 15/133

(52) U.S. Cl. CPC F16F 15/1333; F16F 15/1338; F16F 2230/0064; F16F 2232/02; F16F 2236/08; F16F 2238/024; F16F 2234/06

(57) ABSTRACT

A torsional damper for a torque transmission device, comprising:
a rotationally movable first element (102) and second element (103); and
an elastically deformable blade (117a, 117b) integral with one of the first and second elements;
an abutment element (121) carried by the other of the first and second elements and configured to interact with the blade in such a way that for an angular deflection between the first and second elements with respect to an inactive angular position, the abutment element applies a flexural load onto the blade, producing jointly a reaction force capable of returning the first and second elements to the inactive angular position,
blade has an inner arm (132) and an outer arm (134) connected by a bend (133), the inner arm being situated radially between the outer arm and a rotation axis.

The invention relates to a torsional damper intended to be installed on a torque transmission device. The invention relates more specifically to the sector of motor vehicle transmissions.

### BACKGROUND OF THE INVENTION

In the sector of automotive transmissions, it is known to equip the torque transmission devices with torsional dampers that allow the vibrations and irregularities generated by an internal combustion engine to be absorbed and damped.

The torsional dampers have an input element and an output element that are rotationally movable around a common rotation axis, and elastic damping means for transmitting torque and for damping rotational irregularities between the input element and output element.

Torsional dampers of this kind are installed, in particular, on dual mass flywheels (DMFs) and/or on friction clutches in the case of a manual or automated transmission, or on “lock-up” clutches that are installed on hydraulic coupling devices in the case of an automatic transmission.

The document FR 3000155 depicts a torsional damper having elastic damping means each formed by two elastic blades that are mounted on the input element and each interacting with a respective cam follower mounted on the output element.

The blades and the cam followers are configured in such a way that for an angular deflection between the input element and output element on either side of an inactive relative angular position, the cam follower moves along the blade and, in so doing, applies a flexural load onto the elastic blade. In reaction, the elastic blade exerts on the cam follower a return force that tends to bring the input and output elements back to their inactive angular position. Flexure of the elastic blade thus allows damping of the vibrations and rotational irregularities between the input element and output element while ensuring the transmission of torque.

Such blades are subject to excessive stress when the torque to be transmitted is high, however, and are therefore not adapted for transmitting high torques.

### OBJECT OF THE INVENTION

One aspect of the invention arises from the idea of eliminating the disadvantages of the existing art by proposing an elastic blade-type torsional damper which is particularly effective, and in which the elastic blade is subjected to lower stresses.

According to an embodiment, the invention furnishes a torsional damper for a torque transmission device, comprising:
a first element and a second element rotationally movable with respect to one another around a rotation axis X; and
a blade-type damping means for transmitting a torque and for damping rotational irregularities between the first element and the second element, the blade-type damping means comprising:
   at least one elastically deformable blade integral with one of said first and second elements; and
   at least one abutment element carried by the other of said first and second elements and configured to interact with said at least one blade, said at least one blade being configured such that for an angular deflection between the first and second elements with respect to an inactive angular position, said at least one abutment element applies a flexural load onto said at least one blade, producing jointly a reaction force capable of returning the first and second elements to said inactive angular position,

said damper being characterized in that for a predetermined angular sector, the blade-type damping means has two flexible blade regions offset radially from one another in a radial direction, an open space radially separating said two flexible blade regions.

The superposition of the flexible blade regions thus allows the blades to proceed over greater lengths. Such longer blades are subjected to lower stresses, which allows the transmission of elevated torques.

In addition, a blade configuration of this kind is capable of offering a blade surface with which the abutment element, having a greater circumferential length, interacts. This additional circumferential length of the blade surface with which the abutment element interacts allows a greater angular deflection between the elements, which allows a decrease in the stiffness of the blade and consequently better damping of engine irregularities.

According to other advantageous embodiments, a torsional damper of this kind can have one or more of the following characteristics:
The blade is configured to deform in a plane perpendicular to the rotation axis X.
One of the flexible blade regions is situated between the rotation axis and the other of the flexible blade regions.
Said at least one blade has a free distal end radially movable in such a way that the radial distance separating the rotation axis from said free distal end varies as a function of the angular deflection between the first and the second element.
The angular sector along which the two flexible blade regions are radially offset from one another extends over at least 1°, for example at least 5°, preferably at least 10°, in particular at least 30°.
Said at least one blade has a portion for fastening the blade onto said first or second element and an elastic portion, the elastic portion comprising the free distal end of said at least one blade, said at least one abutment element being configured to interact with the elastic portion of said at least one blade.,
The elastic portion has an inner arm and an outer arm connected by a bend, the inner arm proceeding from the fastening portion to the bend and the outer arm proceeding circumferentially from the bend to the free distal end, the inner arm having one of the two blade regions that are flexible and radially offset from the damping means, and the outer arm having the other of the two blade regions that are flexible and radially offset from the damping means.
The fastening portion proceeds circumferentially and has a thickness in a radial direction which is less than the thickness of the outer arm of the elastic portion.
The fastening portion proceeds circumferentially over a length which is less than the length of the outer arm of the elastic portion.
The fastening portion proceeds circumferentially over a length which is less than 50% of the length of the outer arm, preferably less than 30%.
Said at least one abutment element is arranged radially outside the outer arm of said at least one blade.
The outer arm extends circumferentially over at least 45° and can extend circumferentially up to 180°, in a flexed state of the blade corresponding to a maximum angular deflection between the first element and the second element.
The blade-type damping means has two elastically deformable blades integral with one of said first and second elements, and two abutment elements carried by the other of said first and second elements, the abutment elements being respectively configured to interact with one and the other of the two elastically deformable blades,

and each blade has two flexible blade regions offset radially from one another, an open space radially separating said flexible blade regions of each of the blades.
The blade-type damping means has two elastically deformable blades integral with one of said first and second elements, and two abutment elements carried by the other of said first and second elements, the abutment elements being respectively configured to interact with one and the other of the two elastically deformable blades, and each blade has one of the two flexible blade regions radially offset from one another.
The elastically deformable blades are symmetrical with respect to the rotation axis X.
The distal end of each elastically deformable blade has an inner recess, the recess of one blade having a radius of curvature greater than the radius of curvature of an outer surface of the other blade so that said outer surface of the other blade can become inserted into the recess.
The elastically deformable blades are fastened independently to the first or second element.
The elastic portion has a cam surface, and said at least one abutment element has a cam follower configured to interact with the cam surface.
The cam follower is a wheel mounted rotationally movably on the respective first or second element by means of a rolling bearing.

The invention also relates to a torque transmission element, in particular for a motor vehicle, having an aforementioned torsional damper.

According to other advantageous embodiments, a transmission element of this kind can have one or several of the following characteristics:
The transmission element has two aforementioned torsional dampers arranged in series.
The transmission element has two aforementioned torsional dampers arranged in parallel.

One aspect of the invention arises from the idea of reducing the stiffness of the damping means in order to allow better damping of irregularities. One aspect of the invention arises from the idea of increasing the maximum angular deflection between the input element and the output element. One aspect of the invention arises from the idea of reducing the stress concentration zones on a spring blade. One aspect of the invention is to propose a torsional damper having blades subject to acceptable stresses upon the transmission of a high torque. One object of the invention is to furnish a torsional damper permitting high-quality filtering of irregularities. One object of the invention is to furnish an elastic blade having a long length. One object of the invention is to furnish a blade having a long cam surface.

The invention will be better understood, and other objectives, details, characteristics, and advantages thereof will appear more clearly, in the course of the description below of several specific embodiments of the invention provided solely for illustrative and not for limiting purposes, with reference to the attached Figures.

In those Figures:

FIG. 1 is a frontal view of a dual mass flywheel illustrating the general operation of a torsional damper, in which view the secondary flywheel is depicted as transparent so the damping means can be visualized.

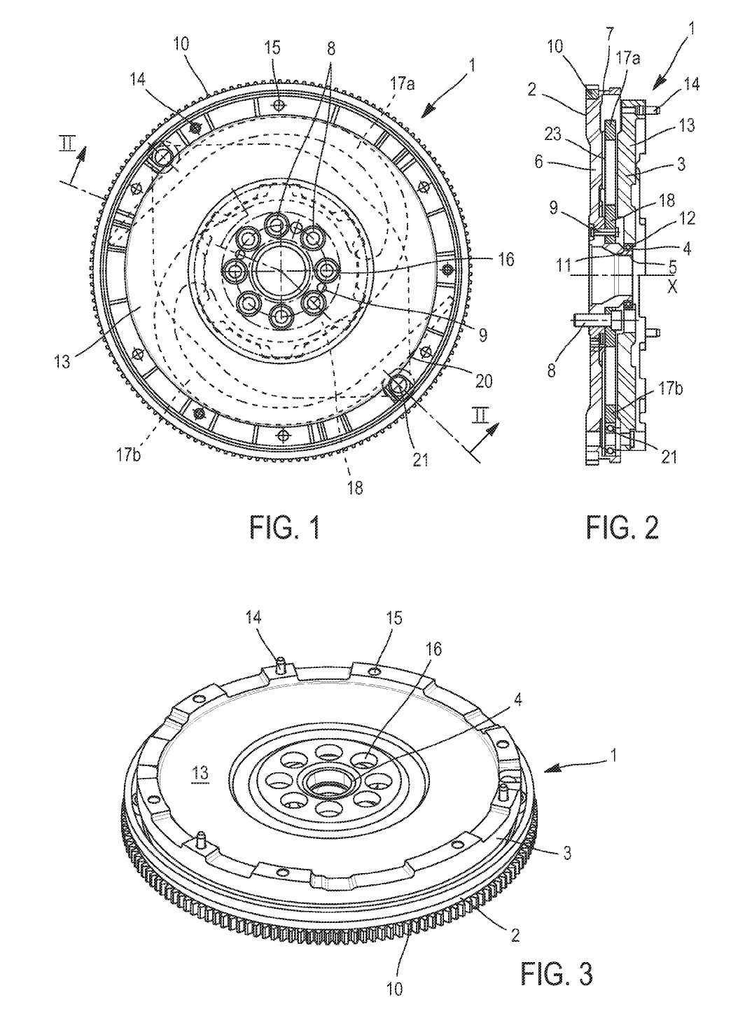

FIG. 2 is a section view along II-II of the dual mass flywheel of FIG. 1.

FIG. 3 is a perspective view of the dual mass flywheel of FIG. 1.

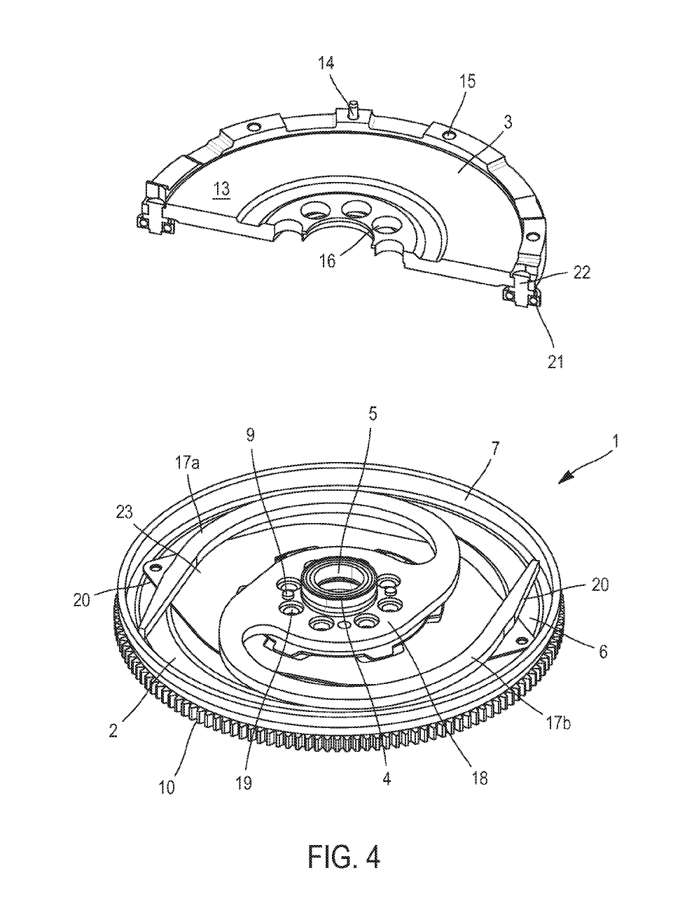

FIG. 4 is a perspective view of the dual mass flywheel of FIGS. 1 to 3 in which the secondary flywheel is shown partly detached and disassembled from the primary flywheel.

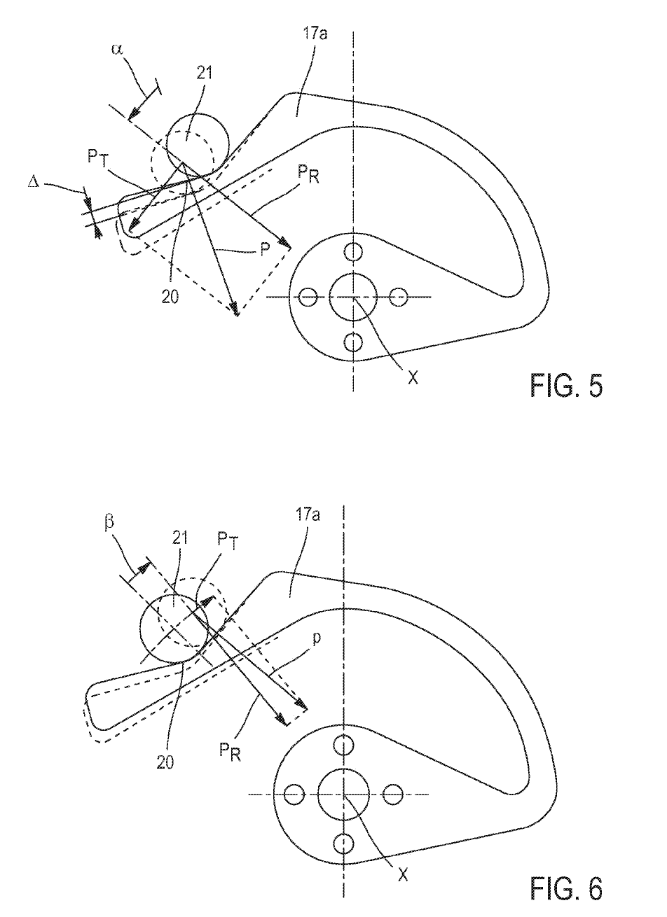

FIG. 5 is a schematic view of an elastically deformable blade, illustrating the flexing of the blade upon an angular deflection between a first element and a second element in a forward direction.

FIG. 6 is a schematic view of an elastically deformable blade, illustrating the flexing of the blade upon an angular deflection between a first element and a second element in a reverse direction.

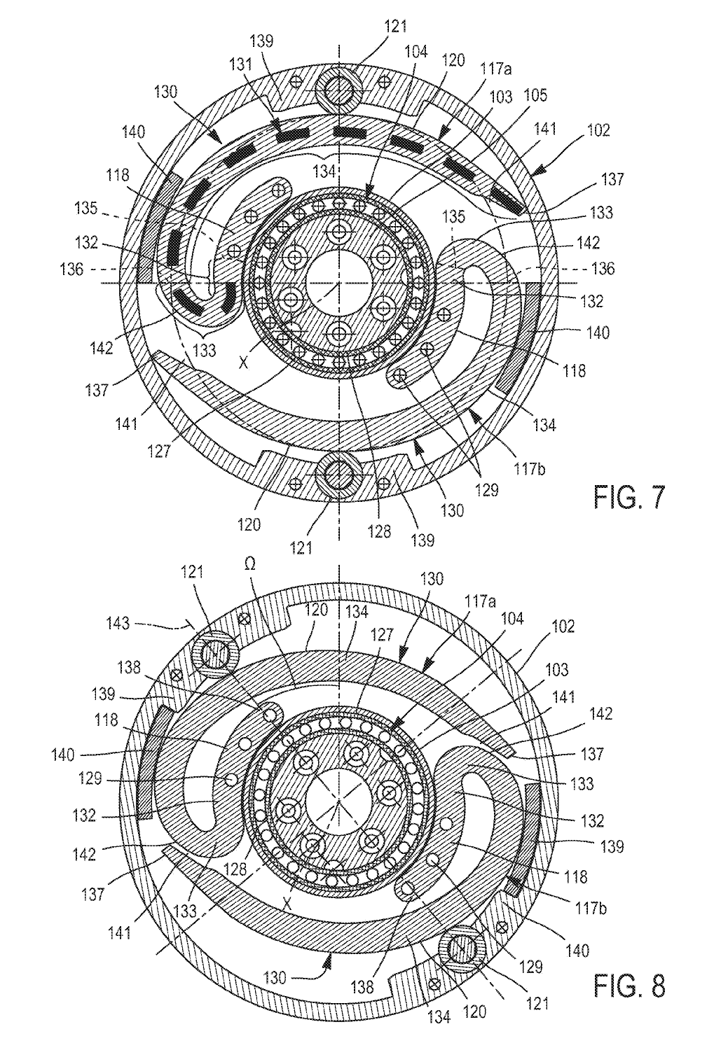

FIG. 7 is a schematic view of a torsional damper in an inactive position, having a damping means according to an embodiment of the invention.

FIG. 8 is a schematic view of the torsional damper of FIG. 7 in an angular deflection position between the first element and the second element.

In the description and the claims, the terms “outer” and “inner” and the “axial” and “radial” orientations will be used to designate elements of the torsional damper in accordance with the definitions given in the description. By convention, the “radial” orientation is directed orthogonally to the rotation axis (X) of the elements of the torsional damper determining the “axial” orientation; and, moving away from said axis from inside to outside, the “circumferential” orientation is directed orthogonally to the rotation axis of the torsional damper and orthogonally to the radial direction. An element described as proceeding “circumferentially” is thus an element one component of which proceeds in a circumferential direction. Similarly, the indication of an angle is interpreted as being delimited by two straight lines of a plane perpendicular to rotation axis X and intersecting at said rotation axis X. The terms “outer” and “inner” are used to define the relative position of one element with respect to another with reference to the rotation axis of the torsional damper; an element close to the axis is thus referred to as “inner,” as opposed to an “outer” element situated radially at the periphery.

Reference will be made firstly to FIGS. 1 to 4, which illustrate the general operation of a torsional damper having elastically deformable blades, installed on a dual mass flywheel 1. Dual mass flywheel 1 comprises a primary flywheel 2 intended to be fastened at the end of a crankshaft of an internal combustion engine (not depicted), and a secondary flywheel 3 that is centered and guided on primary flywheel 2 by means of a ball-type rolling bearing 4. Secondary flywheel 3 is intended to form the reaction plate of a clutch (not depicted) connected to the input shaft of a gearbox. Primary flywheel 2 and secondary flywheel 3 are intended to be mounted movably around a rotation axis X, and furthermore are rotationally movable with respect to one another around said axis X.

Primary flywheel 2 has a radially inner hub 5 supporting rolling bearing 4; an annular portion 6 extending radially from hub 5; and a cylindrical portion 7 extending axially, on the side opposite from the engine, from the outer periphery of annular portion 6. Annular portion 6 is provided on the one hand with orifices for the passage of fastening screws 8 intended for fastening primary flywheel 2 onto the crankshaft of the engine, and on the other hand with orifices for the passage of rivets 9 for fastening a damping means onto primary flywheel 2. Primary flywheel 2 carries on its outer periphery a ring gear 10 to drive primary flywheel 2 rotationally with the aid of a starter.

Hub 5 of the primary flywheel has a shoulder 11 that serves for abutment of an inner ring of rolling bearing 4 and retains said inner ring in the direction of the engine. Secondary flywheel 3 similarly has on its inner periphery a shoulder 12 that serves for abutment of an outer ring of rolling bearing 4 and retains said outer ring in the direction opposite from the engine.

Secondary flywheel 3 has a planar annular surface 13 facing oppositely from primary flywheel 2 and forming an abutment surface for a friction lining of a clutch disc (not depicted). Secondary flywheel 3 has, in the vicinity of its outer edge, studs 14 and orifices 15 that serve for mounting of a clutch cover. Secondary flywheel 3 furthermore has orifices 16 that are arranged facing orifices constituted in primary flywheel 2 and are intended for the passage of screws 8 upon installation of dual mass flywheel 1 on the crankshaft.

Primary flywheel 2 and secondary flywheel 3 are rotationally coupled via a damping means. In the embodiment depicted in FIGS. 1 to 4, this damping means comprises two elastic blades 17a, 17b mounted rotationally integrally with primary flywheel 2. To achieve this, elastic blades 17a, 17b are carried by an annular body 18 equipped with orifices allowing the passage of rivets 9 for fastening onto primary flywheel 2. Annular body 18 furthermore has orifices 19 for the passage of screws 8 for fastening dual mass flywheel 1 to the nose of the crankshaft. The two elastic blades 17a, 17b are symmetrical with respect to rotation axis X of the clutch disc.

Elastic blades 17a, 17b have a cam surface 20 that is configured to interact with a cam follower carried by secondary flywheel 3. Elastic blades 17a, 17b have a curved portion extending substantially circumferentially. The radius of curvature of the curved portion, as well as the length of that curved portion, are determined as a function of the desired stiffness of elastic blade 17a, 17b. Elastic blade 17a, 17b, as desired, can be implemented as a single piece or can be composed of a plurality of strips arranged axially against one another.

The cam followers are wheels 21 carried by cylindrical rods 22 fastened on the one hand to secondary flywheel 3 and on the hand to a web 23. Wheels 21 are mounted rotationally movably on cylindrical rods 22 around a rotation axis parallel to rotation axis X. Wheels 21 are kept in abutment against their respective cam surface 20, and are configured to roll against said cam surface 20 upon a relative motion between primary flywheel 2 and secondary flywheel 3. Wheels 21 are arranged radially outside their respective cam surface 20 in order to locate elastic blades 17a, 17b axially when they are subjected to centrifugal force. In order to reduce parasitic friction capable of affecting damping function, wheels 21 are advantageously mounted on the cylindrical rods rotatably by means of a rolling bearing. As an example, the rolling bearing can be a ball bearing or a roller bearing. In an embodiment, wheels 21 have an anti-friction coating.

Cam surface 20 is configured so that, for an angular deflection between primary flywheel 2 and secondary flywheel 3 with respect to an inactive relative angular position, wheel 21 moves on cam surface 20 and, in so doing, applies a flexural load onto elastic blade 17a, 17b. In reaction, elastic blade 17a, 17b exerts on wheel 21 a return force that tends to return primary flywheel 2 and secondary flywheel 3 to their inactive relative angular positions. Elastic blades 17a, 17b are thus capable of transmitting a driving torque from primary flywheel 2 to secondary flywheel 3 (forward direction) and a resistive torque from secondary flywheel 3 to primary flywheel 2 (reverse direction).

The operating principle of a damping means having elastic blades 17a, 17b is described in detail with reference to FIGS. 5 and 6.

When a driving engine torque is transmitted from primary flywheel 2 to secondary flywheel 3 (forward direction), the torque to be transmitted causes a relative deflection between primary flywheel 2 and secondary flywheel 3 in a first direction (see FIG. 5). Wheel 21 is then displaced over an angle α with respect to elastic blade 17a. The displacement of wheel 21 on cam surface 20 causes flexure of elastic blade 17a over a deflection distance Δ. To illustrate the flexure of elastic blade 17a, elastic blade 17a is depicted with solid lines in its inactive angular position and with dashed lines in the context of an angular deflection.

The flexural load P depends in particular on the geometry of elastic blade 17a and on its material, in particular its transverse modulus of elasticity. The flexural load P is made up of a radial component Pr and a tangential component Pt. The tangential component Pt allows transmission of the engine torque. In reaction, elastic blade 17a exerts on wheel 21 a reaction force whose tangential component constitutes a return force that tends to bring primary flywheel 2 and secondary flywheel 3 back to their inactive relative angular positions.

When a resistive torque is transmitted from secondary flywheel 3 to primary flywheel 2 (reverse direction), the torque to be transmitted causes a relative deflection between primary flywheel 2 and secondary flywheel 3 in a second, opposite direction (see FIG. 6). Wheel 21 is then displaced over an angle with respect to elastic blade 17a. In this case the tangential component Pt of the flexural load is in a direction opposite from the tangential component of the flexural load illustrated in FIG. 5. Similarly, elastic blade 17a exerts a reaction force in a direction opposite from the one illustrated in FIG. 5, so as to bring primary flywheel 2 and secondary flywheel 3 back to their inactive relative angular positions.

The torsional vibrations and torque irregularities that are produced by the internal combustion engine are transmitted by the crankshaft to primary flywheel 2, and generate relative rotations between primary flywheel 2 and secondary flywheel 3. Those vibrations and inconsistencies are damped by the flexing of elastic blade 17a.

FIG. 7 is a schematic view of a torsional damper in an inactive position, having a damping means according to an embodiment of the invention. Referring to FIGS. 7 and 8, elements that are identical or analogous to the elements of FIGS. 1 to 6, i.e. that perform the same function, bear the same reference number incremented by 100.

In FIGS. 7 and 8, elastic blades 117a, 117b are fastened mutually independently onto secondary flywheel 103. Cam followers 121 are fastened onto primary flywheel 102. Each blade 117a, 117b has a fastening portion 118 that is fixed with respect to secondary flywheel 103 in order to permit rotational integration of elastic blades 117a, 117b with secondary flywheel 103.

A ball-type rolling bearing 104 is mounted between primary flywheel 102 and secondary flywheel 103. This ball-type rolling bearing 104 has an outer ring 127 carried by secondary flywheel 103, which interacts with an inner ring 128 carried by primary flywheel 102. Fastening portion 118 of blades 117a, 117b proceeds circumferentially around outer ring 127. Inner ring 128 of ball-type rolling bearing 104 is carried by hub 105 of primary flywheel 102.

Fastening portion 118 of each elastic blade 117a, 117b is fastened to secondary flywheel 103 by three rivets 129. In order to ensure proper fastening of elastic blades 117a, 117b, the three rivets 129 are not aligned along the same axis. Fastening of blade 117a, 117b using fewer than three rivets 129 would not ensure proper fastening. Furthermore, fastening an elastic blade 117a, 117b using a greater number of rivets 129 would produce a space problem in the case of rivets 129 having the same dimensions, and a mechanical strength problem in the case of rivets 129 having smaller dimensions.

Fastening portion 118 fastened on secondary flywheel 103 is prolonged by an elastic portion 130. Elastically deformable portion 130 of blade 117a is depicted schematically in FIG. 7 by a dashed curve 131. Elastic portion 130 carries, on a radially outer face, cam surface 120 that interacts with cam follower 121.

Elastic portion 130 of each elastic blade 117a, 117b has an inner arm 132, a bend 133, and an outer arm 134. Inner arm 132 of a blade 117a, 117b is a prolongation of fastening portion 118. Bend 133 is a prolongation of inner arm 132, and outer arm 134 is a prolongation of bend 133.

Inner arm 132 proceeds circumferentially around outer ring 127 from fastening portion 118 to bend 133. Since inner arm 132 is not fastened onto secondary flywheel 103 with the aid of rivets 129, said arm deforms in the context of an angular deflection between primary flywheel 102 and secondary flywheel 103. Inner arm 133 thus absorbs some of the stresses experienced by elastic blade 117a, 117b in the course of that angular deflection.

Bend 133 forms an angle of approximately 180°, so that a first end 135 of bend 133 adjoining inner arm 132 is situated radially between rotation axis X and a second end 136 of bend 133 adjoining outer arm 134. Elastic blade 117a, 117b thus has the general shape of a hairpin, one branch of which is formed by outer arm 134 and the other branch jointly by fastening portion 118 and inner arm 132. In other words, elastic portion 130 has two flexible blade regions radially offset from one another and separated by an open space.

Outer arm 134 proceeds circumferentially from bend 133 to free end 137 of elastic blade 117a, 117b. Outer arm 134 proceeds over a circumference of at least 45° and can go as far as 180° in the flexed state of elastic blade 117a, 117b. Cam surface 120 proceeds over an outer face of outer arm 134. Advantageously, cam surface 120 proceeds circumferentially over an angle of approximately 125° to 130°. Cam surface 120 proceeds circumferentially with a radius of curvature determined as a function of the desired stiffness of elastic blades 117a, 117b. This cam surface 120 can have different radii of curvature depending on the specific stiffness levels desired, in order to allow changes in the slope of the characteristic curve of the torsional damper representing the torque transmitted as a function of angular deflection.

Elastic blades 117a, 117b that are depicted schematically in FIG. 7 are symmetrical with respect to rotation axis X.

FIG. 8 is a schematic view of the torsional damper of FIG. 7 in an angular deflection position between the primary flywheel and secondary flywheel.

When a driving torque is transmitted from primary flywheel 102 to secondary flywheel 103 (forward direction), the torque to be transmitted causes a relative deflection between primary flywheel 102 and secondary flywheel 103 in a first direction. Wheels 121 are then displaced over an angle Ω with respect to elastic blades 117a, 117b. The displacement of wheels 121 over cam surfaces 120 results in flexure of elastic blades 117a, 117b.

The flexure of elastic blades 117a, 117b on the one hand causes outer arms 134 of blade 117a, 117b to come closer to its fastening portion 118, and on the other hand causes free end 137 of one of blades 117a, 117b to come closer to bend 133 of the other of blades 117a, 117b. Preferably these approaching movements must not result in contacts between outer arm 134 and fastening portion 118 of blade 117a, 117b, since such contacts generate disruptions in the damping of irregularities and vibrations.

To prevent such contacts, the circumferential length of fastening portion 118 is limited in such a way that, in an inactive position illustrated in FIG. 7, fastening portion 118 does not proceed circumferentially beyond the axis formed by the alignment between cam follower 121 and rotation axis X. Preferably, an end 138 of fastening portion 118 opposite elastic portion 130 of a blade 117a, 117b is situated between the corresponding cam follower 121 and rotation axis X in the context of a maximum angular deflection in the reverse direction between primary flywheel 102 and secondary flywheel 103, as depicted by axis 143. A maximum angular deflection of this kind is limited, for example, by an end stop having a stop 139 on primary flywheel 102, circumferentially facing a stop 140 on secondary flywheel 103. In another embodiment that is not depicted, in order to prevent contact between outer arm 134 of an elastic blade 117a, 117b and its fastening portion 118, the thickness of fastening portion 118 is reduced with respect to the thickness of elastic portion 130, and more specifically at least the thickness of end 138 of fastening portion 118 is reduced with respect to the thickness of elastic portion 130.

In order to prevent contact between free end 137 of one of blades 117a, 117b and bend 133 of the other of blades 117b, 117a, free end 137 of blades 117a, 117b has a recess 141. This recess 141 is formed on an inner face of outer arm 134. Recess 141 advantageously has a radius of curvature identical or similar to the radius of curvature of a portion 142 of the outer face of bend 133 of blades 117a, 117b. Upon flexure of blades 117a, 117b, free end 137 of each blade 117a, 117b thus moves closer to bend 133 of the other blade 117b, 117a, and portion 142 of the outer surface of bend 133 of each blade 117b, 117a is received in recess 141 of the other blade 117a, 117b in order to delay or prevent contact.

The length of elastic blade 117a, 117b, as well as the configuration of outer arm 134, of bend 133, and of inner arm 132 of an elastic blade 117a, 117b, allow the transmission of high torque with no risk of degradation of elastic blades 117a, 117b or a loss of interaction between cam followers 121 and cam surfaces 120.

Although the invention has been described in conjunction with several specific embodiments, it is quite apparent that it is in no way limited thereto, and that it encompasses all the technical equivalents of the means described as well as combinations thereof, if they are within the scope of the invention.

In particular, the blades of the damping means can be independent of one another, or connected to one another via a central segment. It is likewise possible to integrate one of the blades of the damping means with one of the elements, and the other of the blades of the damping means with the other of the elements.

The Figures furthermore illustrate a torsional damper in the context of a dual mass flywheel, but a torsional damper of this kind can be installed in any appropriate device. Such torsional dampers can therefore be installed on friction clutches in the case of a manual or automated transmission, or on “lock-up” clutches that are installed on hydraulic coupling devices in the case of an automatic transmission.

Use of the verbs “have,” “comprise” or “include” and of their conjugated forms does not exclude the presence of elements or steps other than those recited in a claim. Use of the indefinite article “a” or “an” for an element or a step does not, unless otherwise indicated, exclude the presence of a plurality of such elements or steps.

In the claims, no reference character in parentheses shall be interpreted as a limitation of the claim.

1. A torsional damper for a torque transmission device, comprising:
a first element (102) and a second element (103) rotationally movable with respect to one another around a rotation axis X; and
a blade-type damping means for transmitting a torque and for damping rotational irregularities between the first element and the second element, the blade-type damping means comprising:
at least one elastically deformable blade (117a, 117b) integral with one of said first and second elements; and
at least one abutment element (121) carried by the other of said first and second elements and configured to interact with said at least one blade, said at least one blade being configured such that for an angular deflection between the first and second elements with respect to an inactive angular position, said at least one abutment element applies a flexural load onto said at least one blade, producing jointly a reaction force capable of returning the first and second elements to said inactive angular position,
wherein for a predetermined angular sector, the blade-type damping means has two flexible blade regions (132, 134) offset radially from one another in a radial direction, an open space radially separating said two flexible blade regions.

2. The torsional damper according to claim 1, wherein said at least one blade has a free distal end (137) radially movable in such a way that the radial distance separating the rotation axis from said free distal end varies as a function of the angular deflection between the first and the second element.

3. The torsional damper according to claim 1, wherein the angular sector along which the two flexible blade regions are radially offset from one another extends over at least 1°, for example at least 5°, preferably at least 10°, in particular at least 30°.

4. The torsional damper according to claim 1, wherein said at least one blade has a portion (118) for fastening the blade onto said first or second element and an elastic portion (130), the elastic portion comprising the free distal end (137) of said at least one blade, said at least one abutment element being configured to interact with the elastic portion of said at least one blade; and
wherein the elastic portion has an inner arm (132) and an outer arm (134) connected by a bend (133), the inner arm proceeding from the fastening portion to the bend and the outer arm proceeding circumferentially from the bend to the free distal end, the inner arm having one of the two blade regions that are flexible and radially offset from the damping means, and the outer arm having the other of the two blade regions that are flexible and radially offset from the damping means.

5. The torsional damper according to claim 4, wherein the fastening portion proceeds circumferentially and has a thickness in a radial direction which is less than the thickness of the outer arm of the elastic portion.

6. The torsional damper according to claim 4, wherein the fastening portion proceeds circumferentially over a length which is less than the length of the outer arm of the elastic portion.

7. The torsional damper according to claim 4, wherein said at least one abutment element is arranged radially outside the outer arm of said at least one blade.

8. The torsional damper according to claim 4, wherein the outer arm extends circumferentially over at least 45° and can extend circumferentially up to 180° in a flexed state of the blade corresponding to a maximum angular deflection between the first element and the second element.

9. The torsional damper according to claim 4, wherein the blade-type damping means has two elastically deformable blades integral with one of said first and second elements, and two abutment elements carried by the other of said first and second elements, the abutment elements being respectively configured to interact with one and the other of the two elastically deformable blades; and in which each blade has two flexible blade regions offset radially from one another, an open space radially separating said flexible blade regions of each of the blades.

10. The torsional damper according to claim 9, wherein the elastically deformable blades are symmetrical with respect to the rotation axis X.

11. The torsional damper according to claim 9, wherein the distal end of each elastically deformable blade has an inner recess (141), the recess of one blade having a radius of curvature greater than the radius of curvature of an outer surface (142) of the other blade so that said outer surface (142) of the other blade can become inserted into the recess.

12. The torsional damper according to claim 9, wherein the elastically deformable blades are fastened independently to the first or second element.

13. The torsional damper according to claim 4, wherein the elastic portion has a cam surface (120); and in wherein said at least one abutment element has a cam follower (121) configured to interact with the cam surface.

14. The torsional damper according to claim 13, wherein the cam follower is a wheel mounted rotationally movably on the respective first or second element by means of a rolling bearing.

15. A torque transmission element, in particular for a motor vehicle, having a torsional damper according to claim 1.

16. The torsional damper according to claim 2, wherein the angular sector along which the two flexible blade regions are radially offset from one another extends over at least 1°, for example at least 5°, preferably at least 10°, in particular at least 30°.

17. The torsional damper according to claim 2, wherein said at least one blade has a portion (118) for fastening the blade onto said first or second element and an elastic portion (130), the elastic portion comprising the free distal end (137) of said at least one blade, said at least one abutment element being configured to interact with the elastic portion of said at least one blade; and
wherein the elastic portion has an inner arm (132) and an outer arm (134) connected by a bend (133), the inner arm proceeding from the fastening portion to the bend and the outer arm proceeding circumferentially from the bend to the free distal end, the inner arm having one of the two blade regions that are flexible and radially offset from the damping means, and the outer arm having the other of the two blade regions that are flexible and radially offset from the damping means.

18. The torsional damper according to claim 3, wherein said at least one blade has a portion (118) for fastening the blade onto said first or second element and an elastic portion (130), the elastic portion comprising the free distal end (137) of said at least one blade, said at least one abutment element being configured to interact with the elastic portion of said at least one blade; and
wherein the elastic portion has an inner arm (132) and an outer arm (134) connected by a bend (133), the inner arm proceeding from the fastening portion to the bend and the outer arm proceeding circumferentially from the bend to the free distal end, the inner arm having one of the two blade regions that are flexible and radially offset from the damping means, and the outer arm having the other of the two blade regions that are flexible and radially offset from the damping means.

19. The torsional damper according to claim 5, wherein the fastening portion proceeds circumferentially over a length which is less than the length of the outer arm of the elastic portion.
